(19) United States
(12) Patent Application Publication
(10) Pub. No.: US 2011/0228229 A1
(43) Pub. Date: Sep. 22, 2011

(54) Stereoscopic Viewing Device and Image Disc System

(76) Inventor: Evangelia Vensel, Spokane, WA (US)

(21) Appl. No.: 12/728,076

(22) Filed: Mar. 19, 2010

(51) Int. Cl. G02B 27/22; G03B 21/14

(52) U.S. Cl. 353/7; 359/466; 359/475

(57) ABSTRACT

Implementations for a stereoscopic viewing device and image disc system are generally disclosed.

### BACKGROUND

FIG. 1 illustrates a prior art disc 100. Disc 100 may include a pair of slides 102, 104. For example, slide 102 may include a slide (e.g. slide 1A) paired with slide 104 that may include a slide (e.g. slide 1B), where slides 1A and 1B may be of a similar but slightly shifted perspective to generate a stereoscopic view. Descriptive text 106 may be associated with a given pair of slides 102, 104. For example, a slide 1 text portion of descriptive text 106 may be associated with slide 102 (e.g. slide 1A) and slide 104 (e.g. slide 1B). As illustrated, slide 1 text portion of descriptive text 106 may be printed on a substrate 108 so as to be positioned perpendicular to an axis running through slide 102 (e.g. slide 1A) and slide 104 (e.g. slide 1B).

FIG. 2 illustrates a prior art viewing device 200 for viewing disc 100. Viewing device 200 may include a pair of viewing lenses 202, 204 coupled to a main body 206. The pair of viewing lenses 202, 204 may be configured to view pairs of image slides. For example, in one possible orientation of disc 100 viewing lens 202 may be configured to view slide 102 (FIG. 1) while viewing lens 204 may be configured to view slide 104 (FIG. 1). In such an orientation of disc 100, the slide 1 text portion of descriptive text 106 may be viewable through an aperture 208 located in main body 206.

In such an orientation, a user may view a image of slide 102 (FIG. 1) and slide 104 (FIG. 1) by applying viewing lenses 202, 204 to the users eyes (not shown). Additionally, a user may view the slide 1 text portion of descriptive text 106 associated with slide 102 (FIG. 1) and slide 104 (FIG. 1) by removing viewing lenses 202, 204 from the users eyes (not shown), and positioning viewing device 200 in spaced relation to the users eyes (not shown).

### BRIEF DESCRIPTION OF THE DRAWINGS

Embodiments are illustrated by way of example and not by way of limitation in the figures of the accompanying drawings, in which like references may indicate similar elements and in which:

FIG. 1 illustrates a prior art image disc;

FIG. 2 illustrates a front view of a prior art stereoscopic viewing device;

FIG. 3 illustrates an example image disc;

FIG. 4 illustrates a front view of an example stereoscopic viewing device;

FIG. 5 illustrates a side view of an example stereoscopic viewing device; and

FIG. 6 illustrates a schematic diagram of an example stereoscopic viewing device.

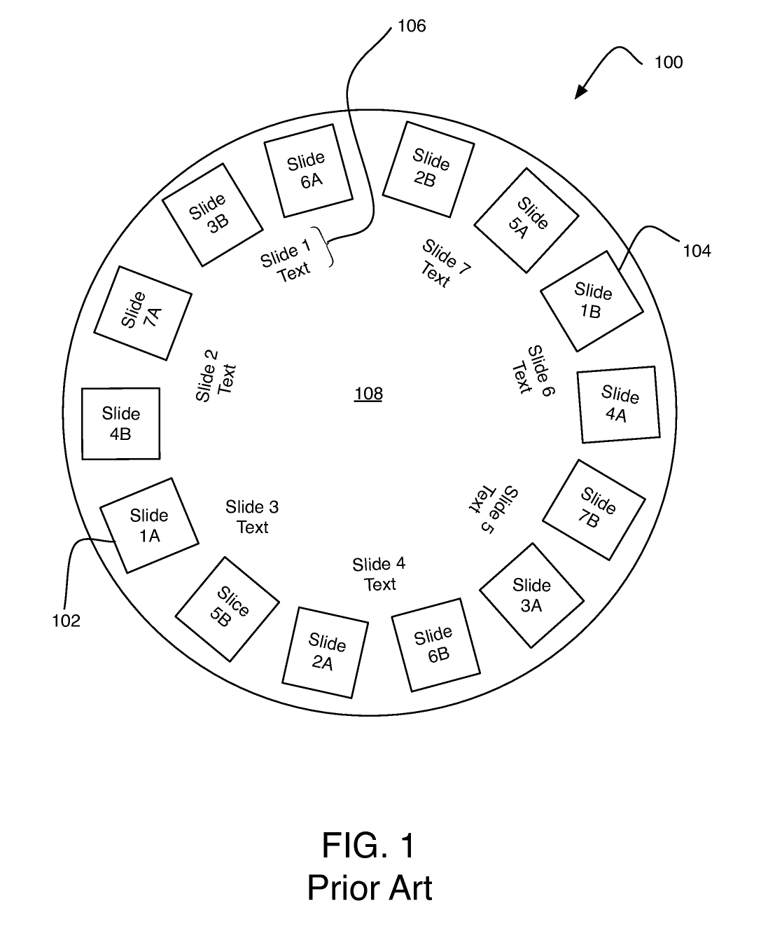

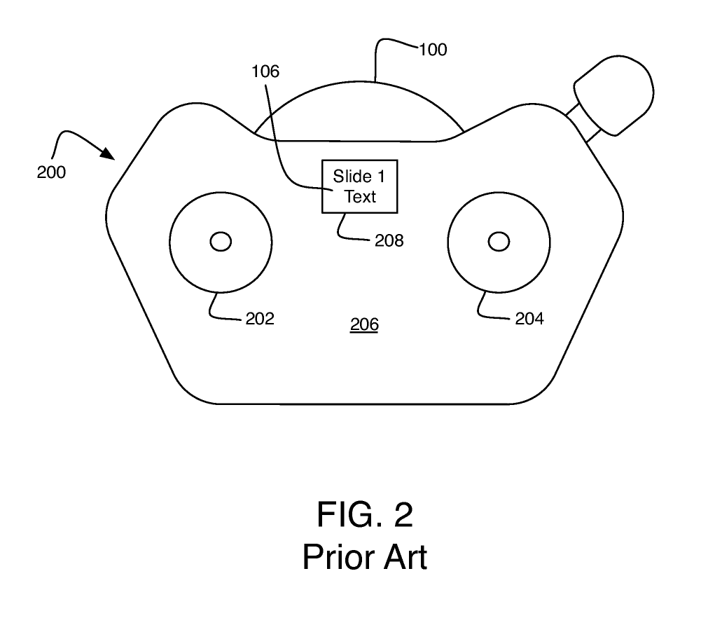

### DETAILED DESCRIPTION

In the following description, various embodiments will be disclosed. However, it will be apparent to those skilled in the art that the embodiments may be practiced with all or only some of the disclosed subject matter. For purposes of explanation, specific numbers and/or configurations are set forth in order to provide a thorough understanding of the embodiments. However, it will also be apparent to one skilled in the art that the embodiments may be practiced without one or more of the specific details, or with other approaches and/or components. In other instances, well-known structures and/or operations are not shown or described in detail to avoid obscuring the embodiments. Furthermore, it is understood that the embodiments shown in the figures are illustrative representations and are not necessarily drawn to scale.

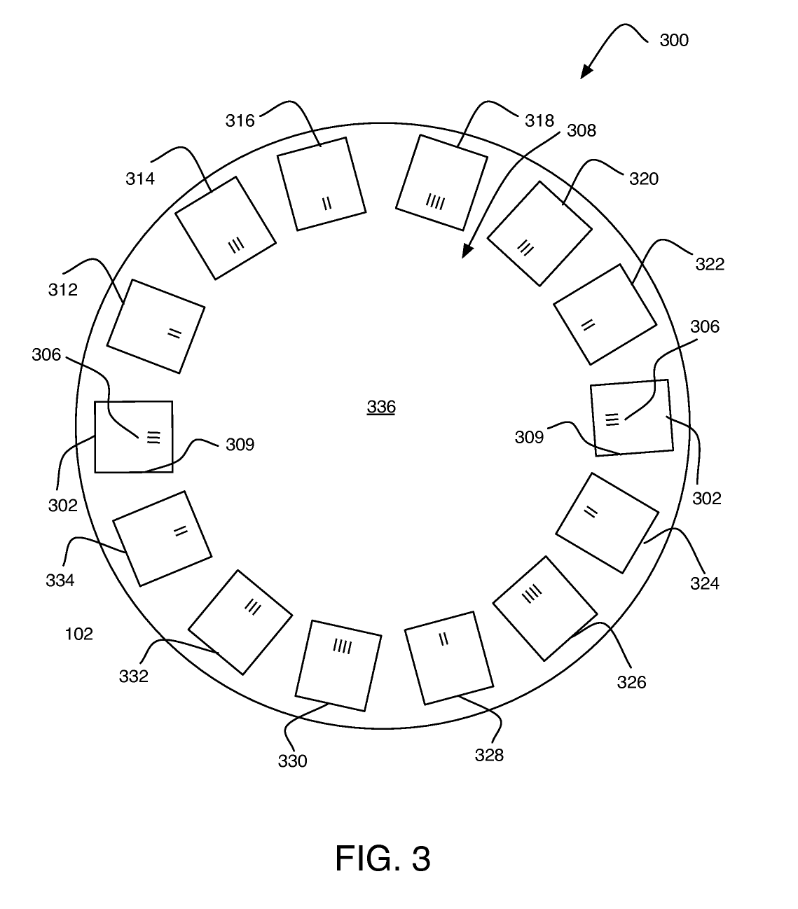

FIG. 3 illustrates an example image disc 300, in accordance with at least some embodiments of the present disclosure. Image disc 300 may include one or more stereoscopic pairs of image slides 302, 304 located in a circular substrate 308. For example, a series of apertures 309 may be located in the circular substrate 308. The stereoscopic pairs of image slides 302, 304 may be coupled to the series of apertures 309. Image slide 302 and image slide 104 may be of a similar but slightly shifted perspective to generate a stereoscopic view.

Descriptive text 306 may be associated with a given pair of slides 102, 104. For example, descriptive text 306 may be associated with slide 302 and slide 304. As illustrated, descriptive text 106 may be printed on slide 302 and/or slide 304. In one example, the descriptive text may be located on each of the one or more image slides 302, 304, 308, and 312-334. As illustrated, such a descriptive text 306 may be excluded from substrate 308 so as to be located only on the one or more stereoscopic pairs of image slides 302, 304. For example, descriptive text 306 may be excluded from an inner portion 336 of the circular substrate 308 located between the two or more apertures 309.

As used herein the term “descriptive text” may include a narrative text portion that may describe a portion of sequence of fictional or non-fictional events. Alternatively, the term “descriptive text” may include a title portion and a fact portion, where such a title portion may label the content of a given stereoscopic pair of image slides, and where such a fact portion may provide factual information regarding the content of a given stereoscopic pair of image slides.

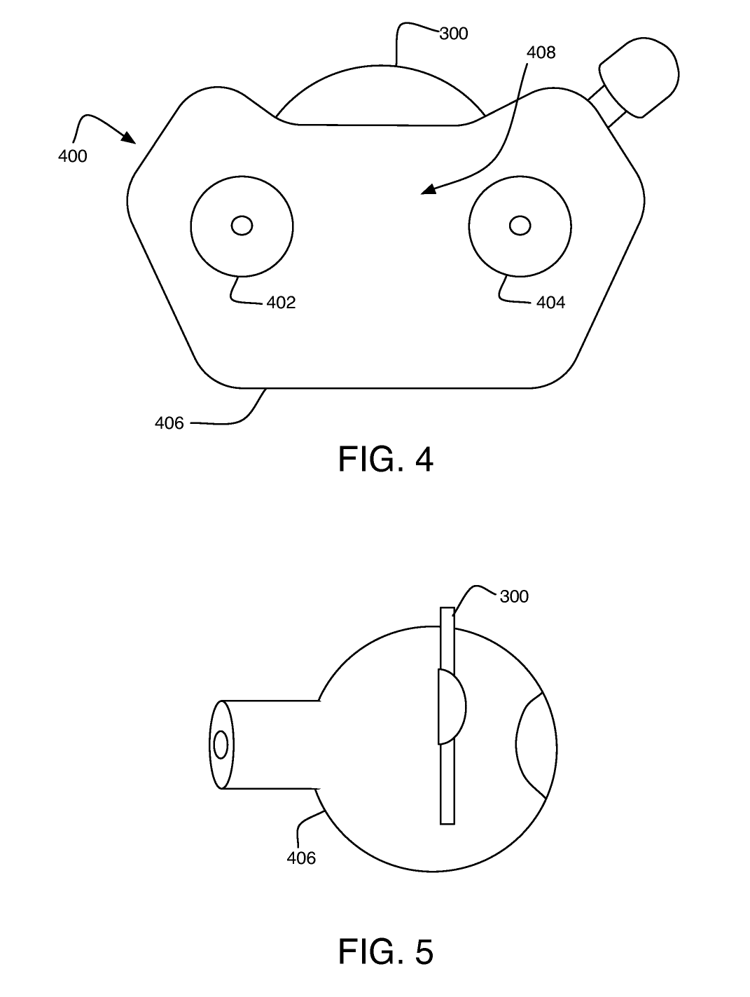

FIG. 4 illustrates a front view of an example stereoscopic viewing device 400, in accordance with at least some embodiments of the present disclosure. Stereoscopic viewing 400 may include a pair of viewing lenses 402, 404 coupled to a main body 406.

FIG. 5 illustrates a side view of an example stereoscopic viewing device 400, in accordance with at least some embodiments of the present disclosure. As illustrated, stereoscopic viewing device 400 may include a slot 502 located in the main body 406. Such a slot 406 may be configured to slidably receive the image disc 300.

Referring back to FIG. 4, the pair of viewing lenses 402, 404 may be configured to view pairs of image slides (not shown) associated with image disc 300. For example, in one possible orientation of disc 300 viewing lens 402 may be configured to view image slide 302 (FIG. 3) while viewing lens 404 may be configured to view image slide 304 (FIG. 3). In such an orientation of disc 300, the descriptive text 306 (FIG. 3), image slide 302 (FIG. 3), and image slide 304 (FIG. 3). may be viewed simultaneously through the pair of viewing lenses 402, 404.

In one example, the main body 406 of stereoscopic viewing device 400 may not have an aperture oriented to frame a portion of the circular substrate 308 (FIG. 3) of the image disc 300. As discussed above, such descriptive text 306 (FIG. 3) may be excluded from inner portion 336 (FIG. 3) of substrate 308 (FIG. 3). For example, such descriptive text 306 (FIG. 3) may be located only on the one or more stereoscopic pairs of image slides 302, 304 (FIG. 3). In examples where the main body 406 of stereoscopic viewing device 400 may not have an aperture oriented to frame a portion of the circular substrate 308 (FIG. 3), the main body 406 may include a solid cover area 408 oriented and arranged to cover all or a portion of inner portion 336 (FIG. 3) of substrate 308 (FIG. 3).

In operation, a user (not shown) may bring stereoscopic viewing device 400 to their eyes in order to view a picture rendered by image slides 302, 304 (FIG. 3). While viewing a picture rendered by image slides 302, 304 (FIG. 3) such a user may simultaneously read descriptive text 306 located on image slides 302, 304 (FIG. 3). Accordingly, a user may read descriptive text 306 (FIG. 3) without having to remove stereoscopic viewing device 400 from their eyes.

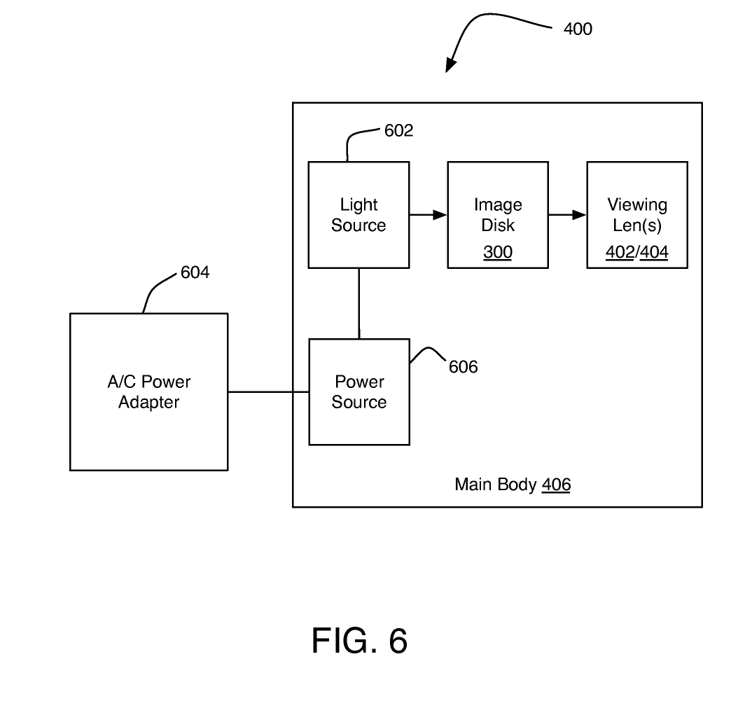

FIG. 6 illustrates a schematic diagram of an example stereoscopic viewing device, in accordance with at least some embodiments of the present disclosure. As illustrated, stereoscopic viewing device 400 may include a light source 602 coupled to the main body 406. The light source 602 may be configured to pass light through the one or more stereoscopic pairs of image slides 302, 304 (FIG. 3) of the image disc 300 to the pair of viewing lenses 402, 404. An A/C power adapter 604 may be coupled to the light source 602. The A/C power adapter 604 may be configured to plug into an A/C outlet or other A/C power source (not shown) and convert A/C power to D/C power for use by the light source 602. In the illustrated example, a power source 606 may additionally be coupled to the light source 602. Such a power source 606 may be coupled to the light source 602 independent from A/C power adapter 604.

Alternatively, such a power source 606 may be coupled to the light source 602 in conjunction with the A/C power adapter 604. In such an example, A/C power adapter 604 may be configured to charge power source 606, such as in an example where power source 606 includes one or more rechargeable batteries.

Alternatively or additionally, light source 602 may include an opening, a transparent surface, or the like configured to admit ambient light into stereoscopic viewing device 400 to illuminate image disc 300.

In other embodiments, FIG. 6 may illustrate a schematic diagram of an example projection viewing device, in accordance with at least some embodiments of the present disclosure. As illustrated, projection viewing device 400 may include a light source 602 coupled to the main body 406. The light source 602 may be configured to pass light through one or more image slides 302, 304 (FIG. 3) of the image disc 300 to a lens 402. An A/C power adapter 604 may be coupled to the light source 602. The A/C power adapter 604 may be configured to plug into an A/C outlet or other A/C power source (not shown) and convert A/C power to D/C power for use by the light source 602. In the illustrated example, a power source 606 may additionally be coupled to the light source 602. Such a power source 606 may be coupled to the light source 602 independent from A/C power adapter 604. Alternatively, such a power source 606 may be coupled to the light source 602 in conjunction with the A/C power adapter 604. In such an example, A/C power adapter 604 may be configured to charge power source 606, such as in an example where power source 606 includes one or more rechargeable batteries.

In operation projection viewing device 400 may project an image by passing light through one or more image slides 302, 304 (FIG. 3) of the image disc 300 to lens 402 and onto a projection surface (not shown). For example, projection viewing device 400 may project an image from one or more image slides 302, 304 (FIG. 3) onto a wall-type projection surface, a ceiling-type projection surface, and/or the like. Accordingly, a user (not shown) may view a picture rendered by image slides 302, 304 while simultaneously reading descriptive text 306 located on image slides 302, 304 (FIG. 3). Accordingly, a user may read descriptive text 306 (FIG. 3) without having to remove the image disc 300 from the projection viewing device 400.

References throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner. Various operations may be described as multiple discrete steps in turn, in a manner that is most helpful in understanding the claimed subject matter. However, the order of description should not be construed as to imply that these operations are necessarily order dependent.

While there has been illustrated and/or described what are presently considered to be example embodiments, it will be understood by those skilled in the art that various other modifications may be made, and/or equivalents may be substituted, without departing from the true scope of claimed subject matter. Additionally, many modifications may be made to adapt a particular situation to the teachings of claimed subject matter without departing from subject matter that is claimed. Therefore, it is intended that the patent not be limited to the particular embodiments disclosed, but that it covers all embodiments falling within the scope of the appended claims.

What is claimed is:

1. An image disc apparatus, comprising:
a circular substrate;
two or more apertures located in the circular substrate; and
one or more stereoscopic pairs of image slides coupled to the two or more apertures, wherein descriptive text is located only on the one or more stereoscopic pairs of image slides.

2. The image disc apparatus of claim 1, wherein the descriptive text comprises narrative text portion that describes a portion of sequence of fictional or non-fictional events.

3. The image disc apparatus of claim 1, wherein the descriptive text comprises a title portion and a fact portion, wherein the title portion labels the content of a given stereoscopic pair of image slides, and wherein the fact portion provides factual information regarding the content of a given stereoscopic pair of image slides.

4. The image disc apparatus of claim 1, wherein the descriptive text is located on each of the one or more stereoscopic pairs of image slides.

5. A system, comprising:
an image disc, comprising:
a circular substrate,
two or more apertures located in the circular substrate, and
one or more stereoscopic pairs of image slides coupled to the two or more apertures, wherein descriptive text is located on the one or more stereoscopic pairs of image slides; and
a stereoscopic viewing device, comprising:
a main body,
a slot located in the main body, the slot configured to slidably receive the image disc,
a pair of viewing lenses coupled to the main body, the pair of viewing lenses configured to view the one or more stereoscopic pairs of image slides,
a light source coupled to the main body, the light source configured to pass light through the one or more stereoscopic pairs of image slides to the pair of viewing lenses, and
an A/C power adapter coupled to the light source.

6. The system of claim 5, wherein the descriptive text comprises narrative text portion that describes a portion of sequence of fictional or non-fictional events.

7. The system of claim 5, wherein the descriptive text comprises a title portion and a fact portion, wherein the title portion labels the content of a given stereoscopic pair of image slides, and wherein the fact portion provides factual information regarding the content of a given stereoscopic pair of image slides.

8. The system of claim 5, wherein descriptive text is located on each of the one or more stereoscopic pairs of image slides.

9. The system of claim 5, wherein descriptive text is located only on the one or more stereoscopic pairs of image slides.

10. The system of claim 5, wherein the main body does not have an aperture oriented to frame a portion of the circular substrate of the image disc located between the two or more apertures.

11. A system, comprising:
an image disc, comprising:
a circular substrate,
two or more apertures located in the circular substrate, and
one or more stereoscopic pairs of image slides coupled to the two or more apertures, wherein descriptive text is located on the one or more stereoscopic pairs of image slides; and
a projection viewing device, comprising:
a main body,
a slot located in the main body, the slot configured to slidably receive the image disc,
a lens coupled to the main body, the lens configured to project the image slides,
a light source coupled to the main body, the light source configured to pass light through the image slides to the lens.

12. The system of claim 11, wherein the descriptive text comprises narrative text portion that describes a portion of sequence of fictional or non-fictional events.

13. The system of claim 11, wherein the descriptive text comprises a title portion and a fact portion, wherein the title portion labels the content of a given stereoscopic pair of image slides, and wherein the fact portion provides factual information regarding the content of a given stereoscopic pair of image slides.

14. The system of claim 11, wherein descriptive text is located on each of the one or more stereoscopic pairs of image slides.

15. The system of claim 11, wherein descriptive text is located only on the one or more stereoscopic pairs of image slides.

16. The system of claim 11, wherein the projection viewing device further comprises an A/C power adapter coupled to the light source.
